(19) United States
(12) Patent Application Publication
(10) Pub. No.: US 2026/0073190 A1
(43) Pub. Date: Mar. 12, 2026

(54) Methods And Apparatus For Estimating Remaining Useful Life

(71) Applicant: Siemens Aktiengesellschaft, München (DE)

(72) Inventors: Cheng Feng, Hangzhou (CN); Fan Wang, Beijing (CN); Sheng Bo Hu, Suzhou (CN)

(73) Assignee: Siemens Aktiengesellschaft, München (DE)

(21) Appl. No.: 19/109,734

(22) PCT Filed: Sep. 8, 2022
(86) PCT No.: PCT/CN2022/117910

§ 371 Date: Mar. 7, 2025

(51) Int. Cl. G06N 3/0464; G01M 13/00; G06N 3/08

(52) U.S. Cl. CPC G06N 3/0464; G01M 13/00; G06N 3/08

(57) ABSTRACT

Various embodiments of the teachings herein include a method for estimating a remaining useful life of a worn part. An example includes: collecting a historical dataset of the worn part, wherein the dataset comprises a plurality of tuples, each tuple including: condition monitoring data and remaining useful life at a time the condition monitoring data is observed; and training a neural network with the historical dataset by using the condition monitoring data as input and generating a parameter of distribution of the remaining useful life as output of the neural network.

### CROSS-REFERENCE TO RELATED APPLICATIONS

This application is a U.S. National Stage Application of International Application No. PCT/CN2022/117910 filed Sep. 8, 2022, which designates the United States of America, the contents of which are hereby incorporated by reference in their entirety.

### TECHNICAL FIELD

Teachings of the present disclosure relate to survival analysis. Various embodiments of the teachings herein include methods and/or apparatus for remaining useful life estimation of a worn part.

### BACKGROUND

Survival analysis is used to analyze data in which the time until the event is of interest. The response is often referred to as a failure time, survival time, or event time. One important goal of survival analysis is to estimate remaining useful life (RUL) of a worn part. Survival analysis can be applied in various industries, such as medical industry, manufacturing industry, agriculture, etc. Taking manufacturing industry as an example, RUL is the length of remaining time for a worn part, like a cutting tool, an engine, or a strap for high voltage bushing, that is still functioning well before it requires repairment or replacement.

By accurately estimating the RUL of a worn part, operators can achieve on-demand repairment or replacement to maximize its usage. For this reason, RUL estimation of a worn part is of vital importance to improve efficiency.

### SUMMARY

In view of this, teachings of the present disclosure include methods and apparatus for remaining useful life estimation of a worn part to provide a more accurate approach for RUL estimation. For example, some embodiments include a method for remaining useful life estimation of a worn part comprising: collecting a historical dataset of the worn part, wherein each tuple in the historical dataset includes: condition monitoring data and remaining useful life at the time the condition monitoring data is observed; and training a neural network with the historical dataset, wherein the condition monitoring data is the input of the neural network and the at least one parameter of distribution of the remaining useful life at the time the condition monitoring data is observed is the output of the neural network. As another example, some embodiments include a method for remaining useful life estimation of a worn part including: collecting real-time condition monitoring data of a worn part; inputting the real-time condition monitoring data into a neural network, wherein the neural network is trained with a historical dataset of the worn part, and each tuple in the historical dataset includes condition monitoring data and remaining useful life at the time the condition monitoring data is observed, the condition monitoring data is the input of the neural network and at least one parameter of distribution of the remaining useful life at the time the condition monitoring data is observed is the output of the neural network; acquiring from output of the neural network, value of the at least one parameter of distribution of the remaining useful life at the time the real-time condition monitoring data is observed.

As another example, some embodiments include an apparatus for remaining useful life estimation of a worn part which can include at least one memory, configured to store computer executable instructions; at least one processor, coupled to the at least one memory and upon execution of the computer executable instructions, configured to execute one or more of the methods described in the present disclosure.

As another example, some embodiments include a computer program product stored on a readable medium of an apparatus, and includes computer executable instructions, wherein the computer executable instructions, when executed, cause at least one processor to execute one or more of the methods described in the present disclosure.

As another example, some embodiments include an apparatus for remaining useful life estimation of a worn part including modules to execute one or more of the methods described in the present disclosure.

In the embodiments of the present disclosure, a neural network takes the condition monitoring data as the input and takes parameter(s) of the RUL distribution as the output. With the flexibility of the neural network, RUL related features for accurate RUL prediction can be automatically learned.

### BRIEF DESCRIPTION OF DRAWINGS

To describe the technical solutions more clearly in embodiments of the present disclosure or the prior art, the accompanying drawings are briefly introduced below. The accompanying drawings in the description below merely represent some of the embodiments of the teachings of the present disclosure. For those of ordinary skills in the art, other drawings may also be obtained based on these drawings.

FIG. 1 is a flowchart of an example method for remaining useful life estimation of a worn part incorporating teachings of the present disclosure;

FIG. 2 is a flowchart of another example method for remaining useful life estimation of a worn part incorporating teachings of the present disclosure;

FIG. 3 is a schematic diagram of an example apparatus for remaining useful life estimation of a worn part incorporating teachings of the present disclosure;

FIG. 4 is a schematic diagram of another example apparatus for remaining useful life estimation of a worn part incorporating teachings of the present disclosure;

FIG. 5 is a schematic diagram of another example apparatus for remaining useful life estimation of a worn part incorporating teachings of the present disclosure;

FIG. 6 shows an example of neural network incorporating teachings of the present disclosure;

FIG. 7 shows the experiment results of RUL estimation, comparing the approach presented in the present disclosure with a regress-based approach and an approach of proportional hazards model (PHM); and

FIG. 8 shows a cutting tool which is cutting an object.

### REFERENCE NUMERALS IN THE FIGURES

10: a cutting tool
20: an object being cut
100: a method for remaining useful life estimation of a worn part
S101: collecting a historical dataset
S102: training a neural network based on the historical dataset
200: the other method for remaining useful life estimation of a worn part
S201: collecting real-time condition monitoring data of a worn part
S202: inputting the real-time condition monitoring data into a neural network
S203: acquire value of parameter(s) of distribution of the RUL
30: an apparatus for remaining useful life estimation of a worn part
301: at least one memory 302: at lest one processor 303: I/O interface
40: another apparatus for remaining useful life estimation of a worn part
401: a data collection module
402: a training module
50: another apparatus for remaining useful life estimation of a worn part
501: a data collection module
502: a data input module
503: a data acquisition module

### DETAILED DESCRIPTION

To better understand the technical solutions, example embodiments of the teachings of the present disclosure are described below with reference to the accompanying drawings. The described embodiments are merely a part, instead of all, of the embodiments of the present disclosure. All other embodiments obtained by those of ordinary skills in the art based on embodiments among the embodiments of the present disclosure shall fall within the scope of protection of the present disclosure.

As mentioned above, RUL estimation of a worn part is of vital importance to improve use efficiency. Currently, there are following two classes of approaches:
1) Regression-based approach fits a regression model such as linear regression model, support vector regression model, etc., to predict the RUL of a worn part based on the condition monitoring data.
2) Survival analysis-based approach fits a survival function model such as proportional hazards model (PHM), accelerated failure time (AFT) model, etc., which assumes the RUL of worn parts follows a particular distribution whose hazard function (which indicates the instantaneous failure rate of a worn part at a specific time point) or failure time is proportional to some RUL related covariates extracted from the condition monitoring data.

However, we find both the approaches have room for improvement. Specifically, the regression-based approach is not data-efficient and tends to underestimate the RUL of worn parts. It is because this approach only models the relationship between the condition monitoring data and uncensored failure data which assumes that the exact time of failure is known. However, in practice, most repair/replacement records of worn parts are censored, meaning that we only know the worn parts are still functioning well until the repair/replacement time, the exact time of failure is unobserved.

The current survival analysis-based approach is more data-efficient than the regression-based approach by fitting a survival distribution of worn parts utilizing both the censored and uncensored data. However, the assumption of these models such as PHM and AFT are often too strong, which means that the assumption, i.e., the failure time or hazard rate is proportional to the covariates of condition monitoring data, can hardly be met, making them unable to model the complex degradation dynamics of worn parts in practice.

In the present disclosure, a survival analysis-based approach is also used which overcomes the shortcomings of strong assumptions of PHM and AFT. By taking advantage of the flexibility of a neural network, the trained neural network can capture the relationship between the distribution of RUL and condition monitoring data, thus the estimation result is more accurate. By considering both censored and uncensored RUL, the approach of the present disclosure is more accurate than the regression-based approach.

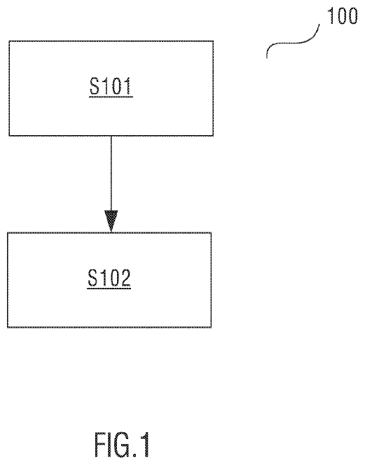

Specific implementations of the embodiments of the present disclosure will be further described below with reference to the accompanying drawings. FIG. 1 is a flowchart of an example method for remaining useful life estimation of a worn part incorporating teachings of the present disclosure. As shown in FIG. 1, the method 100 includes:
S101: collecting a historical dataset of the worn part, wherein each tuple in the historical dataset includes:
condition monitoring data;
remaining useful life at the time the condition monitoring data is observed; and
S102: training a neural network with the historical dataset, wherein the condition monitoring data is the input of the neural network and the at least one parameter of distribution of the remaining useful life at the time the condition monitoring data is observed is the output of the neural network.

In some embodiments, each tuple of the historical dataset also includes censor type of the remaining useful life, and the censor type indicates whether the remaining useful life is censored or not.

For example, in the step S101, a historical dataset {(x,y,z)₁, (x,y,z)₂, . . . , (x,y,z)_{K}} is collected, in which each tuple (x,y,z); includes:
observed condition monitoring data (x);
observed RUL (y) at the time the condition monitoring data (x) is observed; and
censor type (z) of the RUL (y).

Wherein, z is binary valued such that z=1 indicates uncensored which means we know the exact RUL of the worn part is y, z=0 indicates censored which means we only know that the RUL is larger than y.

In some embodiments, let θ be the parameters of the RUL distribution, a neural network model θ=g_{ϑ}(x) can be fit, wherein ϑ is the neural network parameters. The parameters θ depend on the distribution assumed, for example, if the RUL is governed by the lognormal distribution, the parameters can include mean and standard deviation of the RUL's natural logarithm.

In some embodiments, the form of neural network can depend on type of the condition monitoring data in the historical dataset. For example, feed forward network if x is not time series, convolutional network if x is time series.

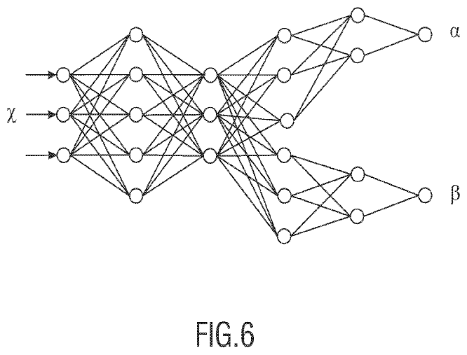

In some embodiments, the RUL can be assumed to follow Weibull distribution, then the distribution can be parameterized by a shape parameter α and a scale parameter β, which means θ=(α, β). The corresponding neural network can be illustrated in the following FIG. 6.

Taking a feed forward network as an example, the probability density function (pdf) of Weibull distribution can be denoted as follows:

$$f ( y ; α , β ) = \{ \begin{matrix}( \frac{α}{β} ) {( \frac{α}{β} )}^{α - 1} {e}^{- {( \frac{y}{β} )}^{a}} & if y \geq 0 \\ 0 & if y < 0\end{matrix} \qquad ( 1 )$$

Wherein f(y; α, β) denotes the probability that a worn part failure occurs at the time y. The corresponding cumulative density function (cdf) can be:

$$F ( y ; α , β ) = 1 - {e}^{- {( \frac{y}{β} )}^{α}} \qquad ( 2 )$$

wherein F (y; α, β) denotes the probability that a failure occurs before time y. Based on the cdf, we can also define the survival function (sf):

$$S ( y ; α , β ) = 1 - F ( y ; α , β ) = {e}^{- {( \frac{y}{β} )}^{α}} \qquad ( 3 )$$

wherein S (y; α, β) denotes the probability that a worn part survives after time y.

In step S102, the neural network can be trained to maximize likelihood of the historical dataset. Taking the example of neural network shown in the FIG. 6, to maximize the likelihood of the observed censored data and uncensored data. In practice, the negative log-likelihood can be calculated and minimized during the training of the neural network by using the following formula:

$${ϑ}^{*} = {min}_{ϑ} - {\sum }_{i = 1}^{K} {z}_{i} \times log f ( {y}_{i} ; {g}_{ϑ} ( {x}_{i} ) ) + ( 1 - {z}_{i} ) \times log S ( {y}_{i} ; {g}_{ϑ} ( {x}_{i} ) ) \qquad ( 4 )$$

Where g_{ϑ}(xᵢ) is the α, β values output by the neural network given condition monitoring data xᵢ.

As shown in formula (4), if the remaining useful life is censored, the likelihood of the historical dataset can be calculated based on probability that the worn part survives after the time of the remaining useful life; if the remaining useful life is uncensored, the likelihood of the historical dataset can be calculated based on probability that the worn part failure occurs at the time of the remaining useful life. With both the censored and uncensored RUL used in the calculation of the likelihood, the trained neural network can provide more accurate RUL estimation.

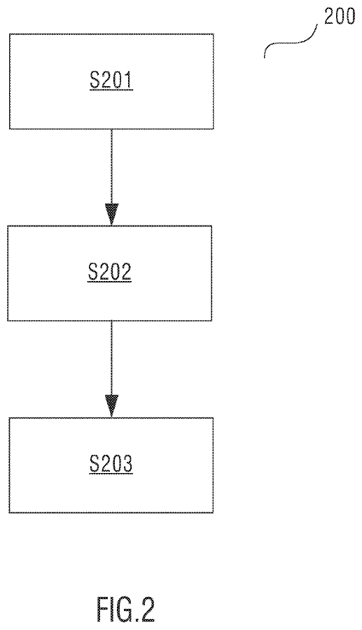

With the neutral network be trained in the method 100, real-time condition monitoring data can be input into the trained neural network to acquire parameter(s) of distribution of RUL, with which the RUL can be estimated. Details the method 200 will be described by referring to FIG. 2.

The method 200 can include:
S201: collecting real-time condition monitoring data of a worn part;
S202: inputting the real-time condition monitoring data into the neural network trained in the method 100;
S203: acquring from output of the neural network, value of the at least one parameter of distribution of the remaining useful life at the time the real-time condition monitoring data is observed.

In the methods 100 and 200, a neural network takes the condition monitoring data as the input and takes the parameter(s) of the RUL distribution as the output. The neural network can automatically learn RUL related features for accurate RUL prediction. For a cutting tool, the feature can be the spindle currents when the cutting tool is working on a work piece.

In some embodiments, the neural network can be trained to maximize the likelihood of observed censored and uncensored data conditioned on the condition monitoring data to maximize the utilization of collected repair/replacement (the formula (4) shows one example).

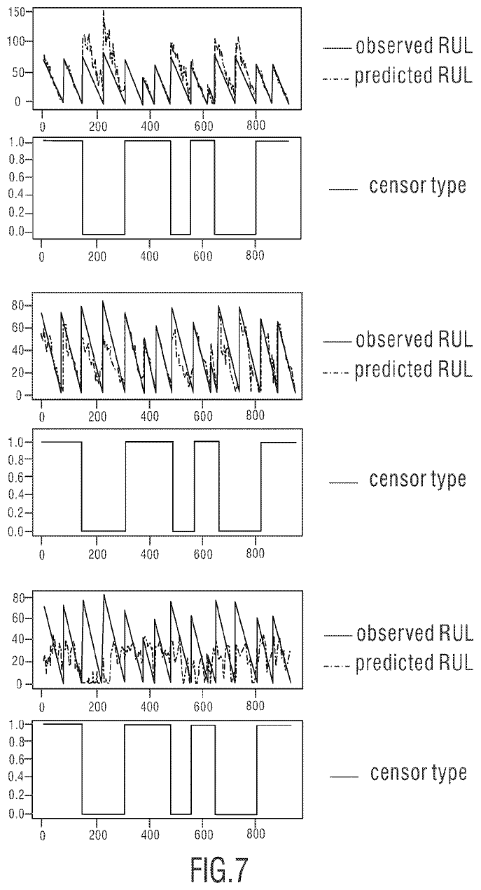

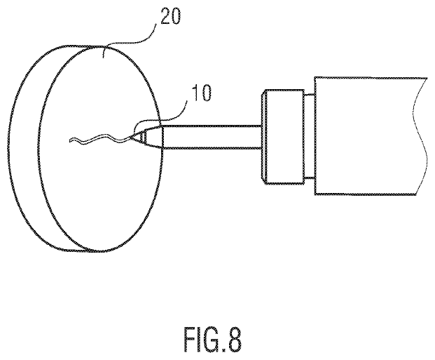

FIG. 7 shows the experiment results of RUL estimation, comparing the approach in the present disclosure with the regression-based approach and the approach of PHM. In the experiment, the neural survival analysis method in the present disclosure is used for RUL estimation of cutting tools (as shown in FIG. 8, the cutting tool 10 is cutting an object 20), specifically the spindle currents when the cutting tool is working on a work piece are used as the condition monitoring data to predict the RUL distribution of the cutting tool.

It is assumed that the RUL of cutting tools follows a Weibull distribution and use a one dimensional (1D) convolutional neural network as the backbone of our prediction model for the distribution parameters. Moreover, the method is compared with a regression-based method which also uses a 1D convolutional neural network as the prediction model, and a survival analysis-based approach where a PHM is used to estimate the RUL. For each method, we compared the predicted RUL (the mode of predicted RUL distribution) with the observed RUL. We show the results for all the methods in the following three figures (top: result of our method; mid: result of regression-based method; bottom: result of PHM). As can be seen, our method can almost perfectly fit the observed RUL, however the regression-based method will underestimate the RUL, the PHM model has the worst accuracy in the experiment. The experiments clearly demonstrate the superiority of our disclosed methods compared with existing methods.

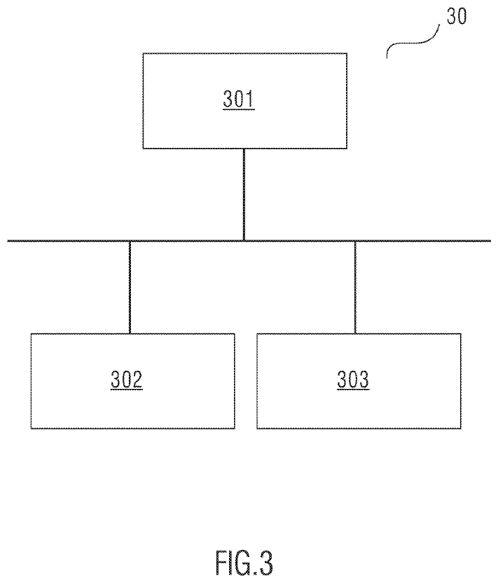

Now, referring to FIG. 3, an apparatus 30 for remaining useful life estimation of a worn part will be introduced. As shown in FIG. 3, the apparatus 30 can include at least one memory 301, configured to store computer executable instructions; and at least one processor 302, coupled to the at least one memory 301 and upon execution of the computer executable instructions, configured to execute the method 100 or the method 200. In some embodiments, the apparatus 30 can further include an I/O interface 303, via which data can be input into the apparatus 30 and output by the apparatus 20.

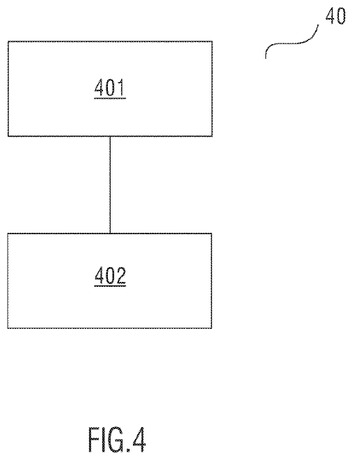

Furthermore, another apparatus for remaining useful life estimation of a worn part is provided, which can be implemented as software installed on the central OT security monitoring server, including modules to execute the method 100. In some embodiments, as shown in FIG. 4, the apparatus 40 can include following modules:
a data collection module 401, configured to collect a historical dataset of the worn part, wherein each tuple in the historical dataset includes: condition monitoring data and remaining useful life at the time the condition monitoring data is observed; and
a training module 402, configured to train a neural network with the historical dataset, wherein the condition monitoring data is the input of the neutral network and the at least one parameter of distribution of the remaining useful life at the time the condition monitoring data is observed is the output of the neural network.

In some embodiments, each tuple of the historical dataset also includes censor type of the remaining useful life, and the censor type indicates whether the remaining useful life is censored or not, when training the neural network with the historical dataset, the training module 402 can be further configured to:
train the neural network to maximize likelihood of the historical dataset, wherein, if the remaining useful life is censored, the likelihood of the historical dataset is calculated based on probability that the worn part survives after the time of the remaining useful life; if the remaining useful life is uncensored, the likelihood of the historical dataset is calculated based on probability that the worn part failure occurs at the time of the remaining useful life.

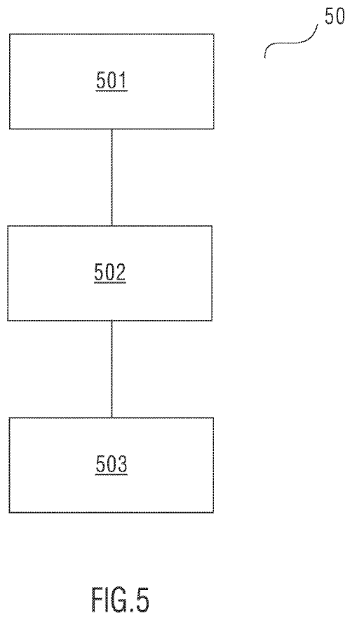

Other optional implementations of the apparatus 40 can be referred to the method 100. Also, another apparatus 50 for remaining useful life estimation of a worn part is provided, which can be implemented as software installed on the central OT security monitoring server, including modules to execute the method 200. Optionally, as shown in FIG. 5, the apparatus 50 can include following modules:
a data collection module 501, configured to collect real-time condition monitoring data of a worn part;
a data input module 502, configured to input the real-time condition monitoring data into a neural network, wherein the neural network is trained with a historical dataset of the worn part, and each tuple in the historical dataset includes condition monitoring data and remaining useful life at the time the condition monitoring data is observed; the condition monitoring data is the input of the neural network and at least one parameter of distribution of the remaining useful life at the time the condition monitoring data is observed is the output of the neural network;
a data acquistion module 503, configured to acquire from output of the neural network, value of the at least one parameter of distribution of the remaining useful life at the time the real-time condition monitoring data is observed.

Other optional implementations of the apparatus 40 can be referred to the method 200. A computer program product stored on a readable medium of an apparatus, and comprising computer executable instructions, wherein the computer executable instructions, when executed, cause at least one processor to execute one or more of the methods described herein.

A computer readable storage medium stores computer executable instructions thereon, where the computer executable instructions, when executed, cause at least one processor to execute one or more of the methods described herein.

It should be noted that, depending on the implementation requirements, the components/steps described herein may be split into more components/steps, or two or more components/steps or partial operations of the components/steps may be combined into novel components/steps to achieve the goal of the embodiments of the present disclosure.

The above methods may be implemented in hardware or firmware, or be implemented as software or computer code storable in a recording medium (such as a CD ROM, RAM, floppy disk, hard disk, or magnetic disk), or be implemented as computer code that is downloaded from a network, is originally stored in a remote recording medium or a non-transitory machine-readable medium, and will be stored in a local recording medium, such that the method described herein may be processed by such software stored on a recording medium using a general-purpose computer, a special-purpose processor, or programmable or dedicated hardware (such as an ASIC or FPGA). It is understandable that a computer, processor, microprocessor controller, or programmable hardware includes a storage component (e.g., RAM, ROM, or flash memory) that can store or receive software or computer code. The method for generating check code described herein is implemented when the software or computer code is accessed and executed by the computer, processor, or hardware. Further, when a general-purpose computer accesses the code for implementing the method for generating check code shown herein, the execution of the code converts the general-purpose computer to a special-purpose computer configured to execute the method for generating check code shown herein.

As will be appreciated by those of ordinary skill in the art, the various example units and method steps described in combination with the embodiments disclosed herein can be implemented by electronic hardware, or a combination of computer software and electronic hardware. Whether these functions are performed by hardware or software depends on specific applications and design constraints of the technical solutions. Those skilled in the art may implement described functions for each specific application using different methods, but such implementation should not be considered as falling beyond the scope of the present disclosure.

The above implementations are only used to illustrate the embodiments of the present disclosure and are not intended to limit the range of embodiments of the present disclosure. Those of ordinary skills in the relevant technical field may further make various alterations and modifications without departing from the spirit and scope of the embodiments of the present disclosure. Therefore, all equivalent technical solutions also belong to the scope of the embodiments of the present disclosure, and the scope of patent protection of the present disclosure should be defined by the appended claims.

What is claimed is:

1. A method for estimating a remaining useful life of a worn part, the method comprising:
collecting a historical dataset of the worn part, wherein the dataset comprises a plurality of tuples, each tuple
including: condition monitoring data
and remaining useful life at a time the condition monitoring data is observed; and
training a neural network with the historical dataset by using the condition monitoring data as input and generating a parameter of distribution of the remaining useful life as output of the neural network.

2. The method according to claim 1, wherein:
each tuple of the historical dataset includes censor type of the remaining useful life indicating whether the remaining useful life is censored or not; and
training the neural network with the historical dataset comprises
training the neural network to maximize likelihood of the historical dataset, wherein:
if the remaining useful life is censored, the likelihood of the historical dataset is calculated based on probability that the worn part survives after the time of the remaining useful life;
if the remaining useful life is uncensored, the likelihood of the historical dataset is calculated based on probability that the worn part failure occurs at the time of the remaining useful life.

3. The method according to claim 1, wherein a form of the neural network depends on a type of the condition monitoring data.

4. The method according to claim 3, wherein the form of the neural network
comprises a feed forward network if the type of the condition monitoring data in the historical dataset is not time series, and
a convolutional network if the type of the condition monitoring data in the historical dataset is time series.

5. The method according to claim 1, wherein:
the worn part comprises a cutting tool; and
the condition monitoring data is monitoring data of a spindle current of the cutting tool.

6. A method for estimating remaining useful life of a worn part, the method comprising:
collecting real-time condition monitoring data of the worn part;
entering the real-time condition monitoring data into a neural network trained with a historical dataset of the worn part;
wherein a plurality of tuples in the historical dataset includes condition monitoring data and remaining useful life at a time the condition monitoring data is observed;
wherein the condition monitoring data comprises input of the neural network and at least one parameter of distribution of the remaining useful life at the time the condition monitoring data is observed comprises output of the neural network; and
acquiring, from output of the neural network, a value of the at least one parameter of distribution of the remaining useful life at the time the real-time condition monitoring data is observed.

7. The method according to claim 6, wherein each tuple of the historical dataset also includes censor type of the remaining useful life, and the censor type indicates whether the remaining useful life is censored or not, and the neural network is trained to maximize likelihood of the historical dataset, wherein:
if the remaining useful life is censored, the likelihood of the historical dataset is calculated based on probability that the worn part survives after the time of the remaining useful life;
if the remaining useful life is uncensored, the likelihood of the historical dataset is calculated based on probability that the worn part failure occurs at the time of the remaining useful life.

8. The method according to claim 6, wherein a form of the neural network depends on a type of the condition monitoring data in the historical dataset.

9. The method according to claim 8, wherein the form of the neural network comprises:
a feed forward network if the type of the condition monitoring data in the historical dataset is not time series; and
convolutional network if the type of the condition monitoring data in the historical dataset is time series.

10. The method according to claim 6, wherein:
the worn part comprises a cutting tool; and
the condition monitoring data comprises monitoring data of the spindle current of the cutting tool.

11-13. (canceled)

14. An apparatus for estimating a remaining useful life of a worn part, the apparatus comprising:
a data collection module to collect a historical dataset including a plurality of tuples for the worn part, wherein each tuple in the historical dataset includes:
condition monitoring data
and remaining useful life at the time the condition monitoring data is observed; and
a training module to train a neural network with the historical dataset, wherein the condition monitoring data is input of the neutral network and the at least one parameter of distribution of the remaining useful life at the time the condition monitoring data is observed is output of the neural network.

15. The apparatus according to claim 14, wherein each tuple of the historical dataset also includes censor type of the remaining useful life, and the censor type indicates whether the remaining useful life is censored or not, when training the neural network with the historical dataset, the training module is further configured to:
train the neural network to maximize likelihood of the historical dataset, wherein,
if the remaining useful life is censored, the likelihood of the historical dataset is calculated based on probability that the worn part survives after the time of the remaining useful life;
if the remaining useful life is uncensored, the likelihood of the historical dataset is calculated based on probability that the worn part failure occurs at the time of the remaining useful life.

16. The apparatus according to claim 14, wherein a form of the neural network depends on a type of the condition monitoring data in the historical dataset.

17. The apparatus according to claim 16, wherein the form of the neural network comprises:
a feed forward network if the type of the condition monitoring data in the historical dataset is not time series; and
convolutional network if the type of the condition monitoring data in the historical dataset is time series.

18. The apparatus according to claim 14, wherein:
the worn part comprises a cutting tools; and
the condition monitoring data comprises the monitoring data of a spindle current of the cutting tool.

19-23. (canceled)
